(19) United States
(12) Patent Application Publication
(10) Pub. No.: US 2006/0085226 A1
(43) Pub. Date: Apr. 20, 2006

(54) Emergency identification, medical treatment and records access authorization media

(76) Inventor: Deirdre J. Kamber, Bethlehem, PA (US)

Correspondence Address: SANFORD J. PILTCH, ESQ., 1132 HAMILTON STREET, SUITE 201, ALLENTOWN, PA, 18101, US

(21) Appl. No.: 11/251,251

(22) Filed: Oct. 14, 2005

Related U.S. Application Data
(60) Provisional application No. 60/618,817, filed on Oct. 14, 2004.

(51) Int. Cl. G06Q 10/00

(52) U.S. Cl. 705/2

(57) ABSTRACT

The single notice or notification of the present invention, whether in printed or electronic media form, provides an authorization to treat in accordance with the guidelines set out by the patient and to contact those persons and entities designated by the patient including medical conditions, medications being taken and allergies of the patient, identification of the patient's primary care physician, identification of an emergency contact: a family member or friend, the existence of a living will, health care proxy and prior appointment of power of attorney for the patient and from what entity a copy of the document(s) can be obtained and the signed written consent of the patient, in a HIPPA-compliant format, authorizing contact, patient health information disclosure and treatment for the patient in accordance with the information provided in the notice. The notice of the current invention also presents aid personnel and others with information focused on the search and recovery of an individual who may be missing or lost.

### BACKGROUND OF THE INVENTION

In our society everything has been miniaturized for greater accessibility and compacting of information. We carry pocket-sized identification cards for almost every imaginable purpose: drivers' licenses, medical insurance information, health club memberships, group and association memberships, and check, debit and credit cards. We carry cellular mobile telephones, pocket-sized computers (personal digital assistants) and miniature digital cameras. And yet, when an emergency arises, we are usually totally unprepared and lack immediate access to the necessary information for a health care provider to proceed with treatment. We do not usually carry emergency contact information with us in case of a life-threatening emergency. If we are incapacitated, or if we lack full awareness, we have no means by which to provide emergency responders, doctors, or other health care providers with immediate access to relatives who can be health care decision-makers, or to other emergency information such as living wills. And now with the advent of health care privacy laws mandating an even greater number of forms to be completed in order to obtain the most comprehensive health care, we are faced with a sea of paperwork when we need to be dealing with our own health or that of a loved one.

Over the past several years, doctors' office and hospital visits have changed drastically. Where every visit used to include a quick review of your insurance coverage, the pre-treatment review now requires a drawn-out process over privacy notices, authorizations for access to medical records, and complicated reviews of permitted access based on granted authorizations. The patient, and sometimes the family, is being asked to sign forms without fully understanding the consequences of the act of signing, and further, confirming that the signer understands the complicated authorities granted and the full legal impact of that grant as it may apply to the signer. The simple truth of the matter is that the forms are long and contain complicated language that is not easy to understand. The forms are required by federal law under the Health Insurance Portability and Accessibility Act [HIPPA] and all health care providers must adhere to the requirements of the Act, as well as the rules and regulations pertaining to, and be in compliance with the standards set out pursuant to 45 C.F.R. §§ 160 and 164.

As complex as health care policies are, these doctors' office and hospital processes are made even more complicated if the patient to be treated is incapacitated, unconscious, or the patient is a minor child for whom a parent is required to sign, and/or you serve as a guardian for the patient, or have a power of attorney to act in the patient's interest. The caretaker of the patient may be cut off from the decisions because there is no ready proof of the power to act in the patient's interest. In a doctors' office, because the staff knows the circumstances of responsibility for a minor child or a caregiver to an older patient, the required paperwork can be completed with only a modicum of inconvenience. However, in time of an emergency when care needs to be provided in as timely a fashion as possible, the patient may not be able to provide the necessary information about a caregiver, a close relative, a guardian, or another person to contact in case of emergency, or provide access to other medical records that may bear on the emergency treatment, and the accompanying caregiver may be prevented from assisting healthcare providers because that person cannot prove authorization to agree to treatment and/or be granted access to medical records of the patient.

Missing persons were a concern in the past and are still a great concern today. Every day there is news of a person gone missing. Children are abducted, both by strangers and by someone they know, including parents. Young people run away, are kidnapped or make risky choices. Adults simply disappear. Individuals with Alzheimer's or dementia frequently wander. Substance abuse, mental illness and unfamiliar surroundings can affect us all. No one can imagine their loved one disappearing, but every missing person has a family and friends who cannot imagine life without them. Experts say that the first forty-eight hours of a disappearance are crucial. The sooner a missing person's full information is available to authorities, the more likely it is they will be found. Yet, obtaining a person's full information can waste valuable hours if the information is not easily at hand. Both physical and biological descriptions of a missing person will aid in their search. Also, once a person is found he or she may need immediate medical attention, which includes knowing any current medical conditions of the person or knowing who to contact to obtain a medical background of the individual.

It is, therefore, an object of the present invention to provide a written instrument, in the form of an emergency authorization form complying with the recently restrictive measures of HIPPA, in the form of a card to conveniently be carried by the user.

It is a further object of the present invention to provide an instrument, in written or electronic format, that will be universally accepted, as well as to fully comply with the requirements of patient confidentiality.

It is a still further object of the present invention to incorporate additional information that is tangential to the privacy information of HIPPA so as to provide a more encompassing set of information to the healthcare provider concerning medical and legal information of the patient, the authorized caregiver, and other important persons and entities that the healthcare provider needs to contact in order to afford the patient the best care possible, even in emergency circumstances.

It is another object of the present invention to provide a written authorization to the healthcare provider to access prior medical information and records of the patient and to initiate contact with designated persons and entities on behalf of the patient to learn of additional information to provide the best possible treatment for the patient.

It is yet another object of the present invention to incorporate additional identifying information that is tangential to the search and recovery of a missing person.

Other objects will appear hereinafter.

### SUMMARY OF THE INVENTION

The present invention is intended to provide, within a single written or electronic media notice or notification, an authorization to treat in accordance with the guidelines set out by the patient and to contact those persons and entities designated by the patient. This notice includes, but is not strictly limited to, personal identification information, such as name, address, telephone number and date of birth, photo identification, medical conditions, medications being taken and allergies of the patient, identification of the patient's primary care physician, identification of the patient's health insurance provider, identification of an emergency contact: a family member or friend, and the existence of a living will, health care proxy and appointment of power of attorney for the patient and from what entity a copy of the document(s) can be obtained. The notice includes the signed written consent of the patient, in a HIPPA-compliant format, authorization to contact and to treat the patient in accordance with the information provided in the notice.

The present invention is intended to be contained within a format that is easily transportable, preferably in the form and size of an identification card, a booklet, an information sheet with magnetic backing, an identification bracelet, a USB memory card or flash memory, a compact disc or other forms of written or electronic media. The identification sized form can be two-sided or be four-sided and be attached by a foldable hinge so that the overall size of the identification form remains similar in overall size to any other identification form. The magnetic backing of the information sheet allows the sheet to be placed on a refrigerator or filing cabinet for quick and easy access to the information. The identification bracelet is engraved with critical information to provide emergency responders or caregivers assistance in treating a lost or missing person. Such critical information includes, but is not strictly limited to, an individual's name, emergency contact information and medical information. The USB memory device, compatible with most standard computer systems, can be combined with a keychain or a pocket clip for easy travel use.

The identification form for medical treatment can contain as much, or as little information about the patient, prior treatment information, contact information, etc., as desired by the patient. But, in all cases where medical treatment is intended to be sought, the HIPPA-compliant authorization will appear so that appropriate treatment can be provided at the earliest possible time to the patient.

The present invention is also intended to provide, within a single written or electronic media notice or notification, information assembled to assist in the search and recovery of a missing person. This notice includes, but is not strictly limited to, a physical and biological description of the individual, including gender, height, age, eye and hair color, blood type and any identifying marks, personal identification information, photo identification, identity confirmation information, such as fingerprints and DNA samples, identification of an emergency contact and an alternative contact: a family member or friend, medical conditions, identification of the individual's health insurance provider, identification of the individual's primary care physician and dentist and the individual's local emergency aid and personnel contact information, such as the police, poison control, fire department and ambulance center. Further provided is a CodeAmber™ CD with a program for creating a Code Amber Alert if a child goes missing. The Code Amber program can be uploaded to a computer system to be sent out as a regional or national Amber Alert. The program is also configured to print and publish flyers and other identifying information for the public.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a perspective view of one embodiment of the emergency medical treatment and records authorization card of the present invention having two connected segments and shown with one segment overlapping the other.

FIG. 2 is a plan view of the medical emergency and records authorization information content of the front face of the first segment of the emergency medical treatment and records authorization card of FIG. 1.

FIG. 3 is a plan view of the medical emergency and records authorization information content of the back face of the second segment of the emergency medical treatment and records authorization card.

FIG. 4 is a plan view of the medical emergency and records authorization information content of the back face of the first segment of the emergency medical treatment and records authorization card of the present invention.

FIG. 5 is a plan view of the medical emergency and records authorization information content of the front face of the second segment of the emergency medical treatment and records authorization card.

FIG. 6 is a plan view of the information content of the front face of an information sheet of the notice of the present invention.

FIG. 7 is a plan view of the information content within an ID bracelet of the present invention.

FIG. 8 is a plan view of the identity confirmation and medical emergency information content of the front face of the first segment of the emergency medical treatment and records authorization card of FIG. 1.

FIG. 9 is a plan view of the identity confirmation and medical emergency information content of the back face of the second segment of the emergency medical treatment and records authorization card.

FIG. 10 is a plan view of the identity confirmation and medical emergency information content of the back face of the first segment of the emergency medical treatment and records authorization card.

FIG. 11 is a plan view of the identity confirmation and medical emergency information content of the front face of the second segment of the emergency medical treatment and records authorization card.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

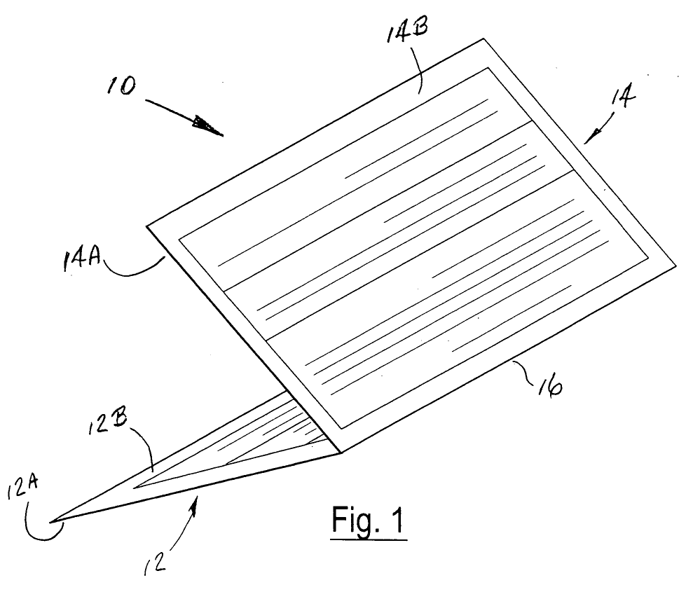

Referring now to the drawings in detail, where like numerals refer to like parts or elements, there is shown in FIG. 1 identification and notification card 10. The card 10 is configured in two segments 12, 14 joined by a flexible hinge 16 in the form shown in the drawing. The card 10 may also be sized with the same overall dimensions as that of other forms of identification cards, e.g. drivers' licenses, etc., or in larger dimensions and be comprised of only a single segment 12.

The card 10, as shown in FIG. 1, is joined at the flexible hinge 16 so that each segment 12, 14 can be folded over the other so as to form a folder having two sides each containing one identification-sized card. Each segment 12, 14 has a front face 12A, 14A and a rear or back face 12B, 14B. Each face contains different sets of information, notices and authorizations as discussed more fully below.

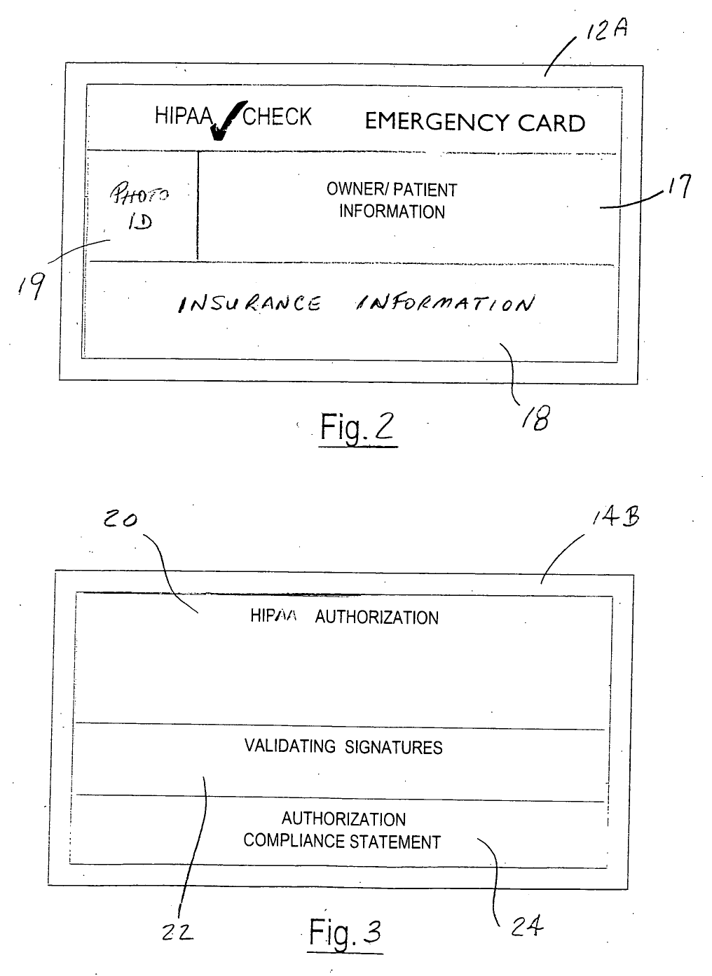

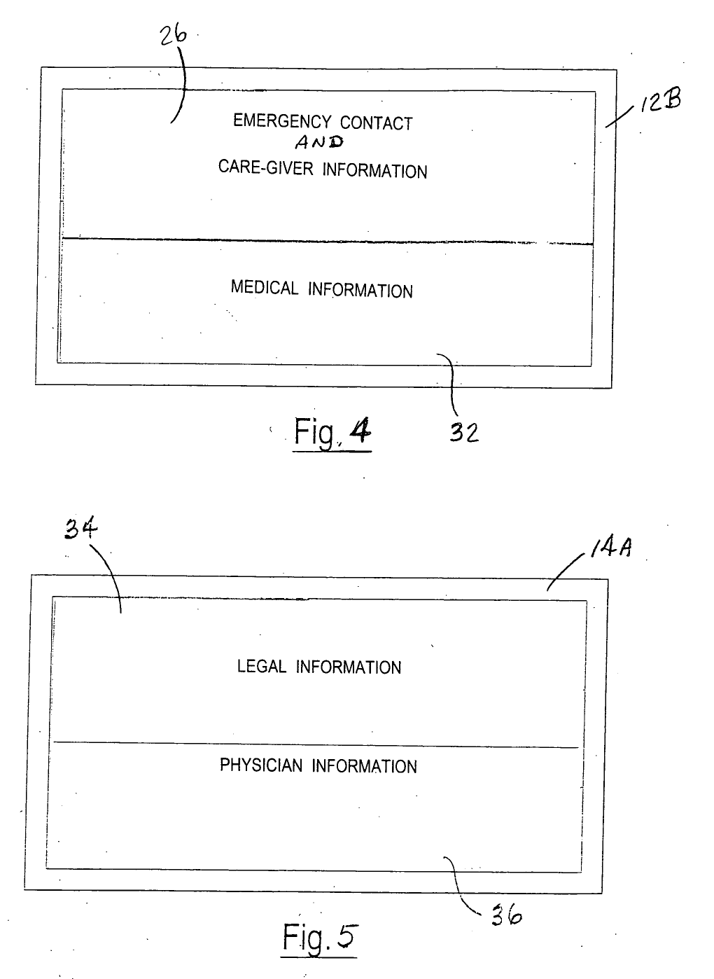

Referring now to FIGS. 2-5, the front face 12A of the first card segment 12 contains the information describing the type of identification and notice card that the patient is using and presenting at time of treatment. This front face 12A contains the name of the card 10—HIPPA✓CHECK EMERGENCY CARD—so that it may be easily identified by healthcare providers when presented by patients during office visits to doctors, or consulted when the patient is not able to provide the card and the information and notices contained thereon during emergency circumstances. The card 10 also provides identification information for the patient in an Owner/Patient Information section 17, a Medical Insurance Information section 18 and a photo identification section 19 of card segment 12A. The patient information provides the identification of the patient, e.g., name, address and telephone number. The medical insurance information includes the name of the insurer, the policy identification number(s) and the principal subscriber name and relationship to the patient. The HIPPA identification and authorization notice card 10 can, and should be used by patients seeking treatment and be produced at the same time insurance and Medicare cards are presented to the healthcare provider. This will greatly ease the required drawn out communications concerning patient medical records and treatment protocol privacy issues and reduce the amount of paperwork needed prior to initiating or continuing treatment of the patient.

It is important to understand exactly what the HIPAA law requires of individuals and healthcare providers. This law requires healthcare providers to restrict access to patient information, i.e., medical records, of anyone eighteen (18) years of age or older without an authorization (in writing) to provide access to a designated individual. Since healthcare providers are mandated not to disclose patient information, except when presented with a written authorization, a signed authorization is required for children or other family members older than 18, including parents, spouses (or significant other companions), and individuals under the care of a non-relative adult, even those with diminished mental capacities or debilitating illnesses. Lacking a written authorization, the healthcare provider will not disclose information of a patient regarding treatment protocols, etc.

The HIPPA identification and authorization notice card 10 provides the temporary, emergent authorization required under the Act so that healthcare providers will share patient information with the individual(s) identified and designated in the authorization. The HIPAA Authorization section of the card 10 appears on card segment 14B. The HIPAA Authorization 20 provides enabling language, in the form of a specific authorization, for a healthcare provider to disclose patient health information to the designated individual(s) listed on the card 10. The designated individual(s) may include a parent, child, sibling, spouse (or significant other companion), legal guardian, or other individual having a power of attorney for the patient. The Validating Signatures 22 located on the card segment 14B provides the healthcare provider with the signature of the patient providing the authorization, as well as the signature(s) of the individual(s) accepting the disclosure of the patient health information. The signatures require an effective date and are valid for one (1) year from that date in accordance with the Act, unless otherwise voided earlier. Card segment 14B also contains an Authorization Compliance Statement 24 that provides that the foregoing authorization complies with the standards set out by HIPAA and its related regulations.

The card 10 also provides on card segment 12B identification of persons that may be contacted in times of an emergency within an Emergency Contact and Care-Giver Information section 26. The Emergency Contact Information provides the name, telephone number (or other contact information) and relationship to the patient in order that the healthcare provider can contact this individual in time of emergency and to provide the name of the authorized individual to whom the healthcare provider is permitted to disclose patient health information. The Care-Giver Information, also located in section 26, provides additional information regarding the emergency contact individual, or other caregiver of the patient, in order that the healthcare provider has immediate knowledge to whom it is permitted to divulge confidential patient health information. Segment 12B also provides the healthcare provider with information pertaining to current healthcare considerations and circumstances of the patient under Medical Information 32. The Medical Information may include, but is not limited to, a listing of allergies, current medications and dosages, and other important health conditions of the patient.

The last card segment 14A provides Legal Information 34 providing the healthcare provider with specific information pertaining to the existence of legal documents that may have a bearing on treatment protocols afforded the patient. These legal documents may include, but are not limited to, living wills, health care proxies, and powers of attorney that include contact names for the individual(s) identified along with other contact information that will enable the healthcare provider to immediately notify the named individual(s). Physician Information 36, also located on card segment 12B, provides the healthcare provider with information identifying the patient's primary care physician, as well as a means to immediately contact that doctor or medical practice to obtain a patient's medical history in order to afford appropriate treatment protocols to the patient. This information can be augmented to include contact information for the patient's dentist and a means for obtaining dental records in the case of emergency or as a means for confirming identity.

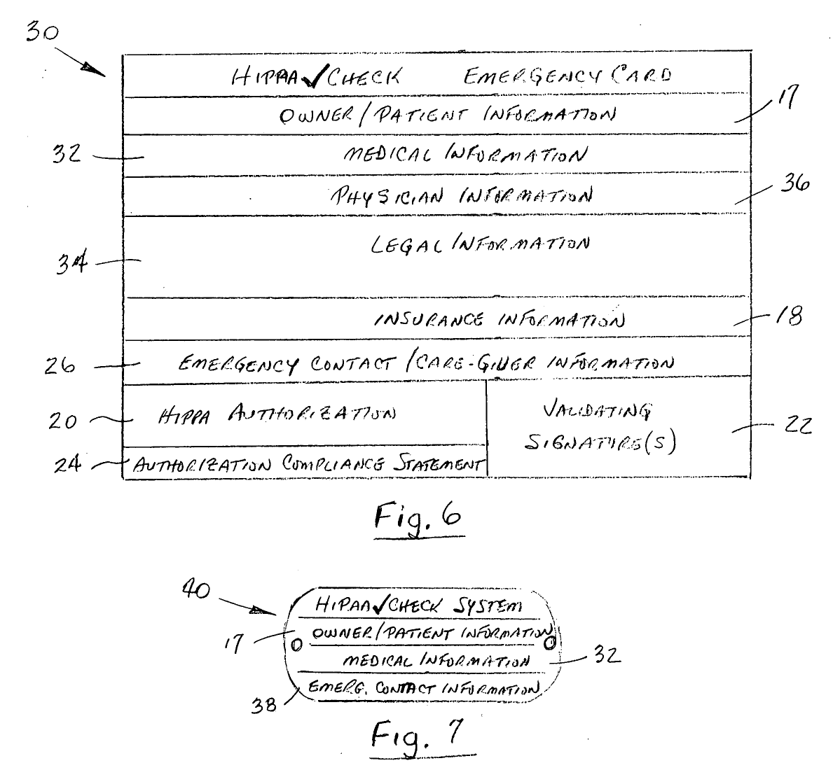

Referring now to another embodiment of the present invention, there is shown in FIG. 6 an information sheet 30. Information sheet 30 can have a magnetic backing to enable the information sheet to be placed on a magnetic surface, such as a refrigerator or filing cabinet. The outward facing surface of information sheet 30 displays the name of the emergency medical treatment and records authorization—HIPPA✓CHECK EMERGENCY CARD—so that babysitters, roommates and caretakers who may have to present such information to healthcare personnel during emergency circumstances may easily identify it. The sheet 30 provides a number of sets of information arrayed across the sheet including Owner/Patient Information 17, Insurance Information 18, HIPPA Authorization 20, Validating Signatures 22, Authorization Compliance Statement 24, Emergency Contact and Care-Giver Information 26, Medical Information 32, Legal Information 34 and Physician Information 36.

Another embodiment of the present invention is shown in FIG. 7. An identification bracelet 40 is shown in FIG. 7 which contains crucial information about its wearer and is particularly useful to individuals who may lose their own self-awareness, such as those with dementia or Alzheimer's. Identification bracelet 40 displays the name of the emergency medical treatment and records authorization—HIPPACHECK SYSTEM—so that it may be easily identified. Due to space restrictions, the information on bracelet 40 is targeted to that which will be most useful for the immediate attention of the individual or to aid the individual in contacting someone who may be of greater help. Such information sections include, but are not limited to, Owner Information 17, Emergency Contact and Care-Giver Information 26, and Medical Information 32.

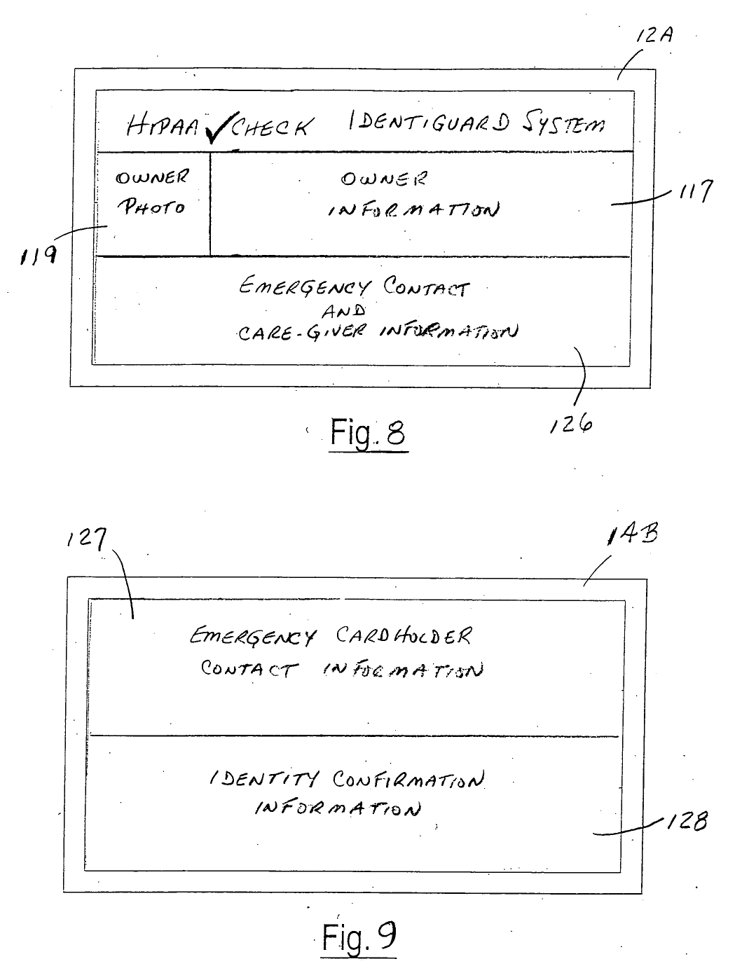

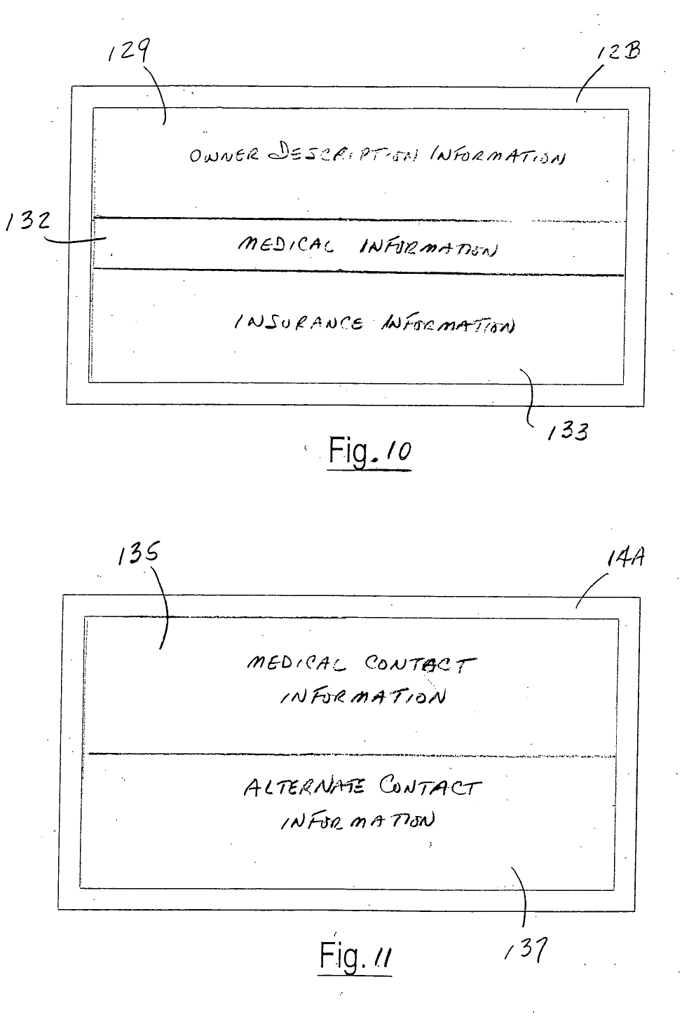

Referring now to FIGS. 8-11, another embodiment of the present invention containing the same, as well as additional information sets. The front face 12A of the first card segment contains information describing the type of identification and notice card that pertains to a missing individual. This front face 12A contains the name of the card 100—HIPPA✓CHECK INDENTIGUARD SYSTEM—so that those person(s) searching for a missing individual may easily identify it. The card 10 also provides identification information for the owner or carrier in Owner Information 117. The owner information provides the identification of the owner, or the missing person, e.g., name, address and telephone number. Also contained on front face 12A is Emergency Contact and Care-Giver Information 126. The emergency contact information provides the name, telephone number (or other contact information) and relationship to the missing individual in order to contact such a person for more information on the missing person or in the event the missing person is located. The care-giver information of card section 126 provides additional information regarding the emergency contact individual, or other care-giver of the card owner, in order that the emergency responder or other aid personnel have immediate knowledge to whom it is permitted to divulge confidential patient health information.

The Identiguard System card 100 also provides on card segment 14B identification of persons that may be contacted for further identity information, such as information on a HIPPA✓CHECK EMERGENCY CARD, fingerprints, or DNA samples. Emergency Card Holder Contact Information 127 provides the name, telephone number (or other contact information) and relationship to the missing person in order that a healthcare provider can contact this individual in time of emergency and to provide the name of the authorized individual to whom the healthcare provider is permitted to disclose patient health information. Identity Confirmation Information 128 provides the name, telephone number (or other contact information) and relationship to the missing person of a person or persons who possess further identifying information, such as fingerprints and DNA samples, for the missing person that may aid in a search.

Further identifying information is provided on card segment 12B. Owner Description Information 129 provides a physical and biological description of the individual, including but not limited to: gender, height, weight, age, eye and hair color, blood type and identifying marks, such as birthmarks, tattoos, scars or any other unique physical identifiers. Medical Information 132 provides aid personnel with information pertaining to current healthcare considerations and circumstances of an individual and may include, but is not limited to, a listing of allergies, current medications and dosages, and other important health conditions of the individual. For further medical treatment purposes Insurance Information 133 is also provided and includes the name of the insurer, the policy identification number(s) and the principal subscriber name and relationship to the patient.

The final card segment 14A provides additional contact information to aid in the treatment, identification and/or search of a missing person. Medical Contact Information 135 provides information identifying the person's primary care physician and dentist, as well as a means to immediately contact that doctor or medical practice to obtain a person's medical history and dental records in order to afford appropriate treatment protocols to a located person or to provide other identifying information to aid in a search. For similar reasons, so as to provide an additional emergency contact, Alternative Contact Information 137 is provided as an additional source in the event the emergency contact is unavailable. Alternative Contact Information 137 provides the name, telephone number, address (or other contact information) and relationship to the missing person in order that the alternative contact may be contacted in emergency situations.

In sum, each of the various HIPPA identification and authorization notice media described above, i.e., the HIPPA✓CHECK EMERGENCY CARD 10, 30; the HIPPACHECK SYSTEM 40; and, the HIPPA✓CHECK IDENTIGUARD CARD 100, provides the necessary information and the required authorization to a healthcare provider to obtain prior medical information about the patient and to discuss appropriate treatments with the designated individual(s) authorized by the patient to receive the patient health information. The card 10 complies with the renewability requirements of the authorization and requires a revalidation annually. The various media, the cards 10, 30 and 100, and the bracelet 40, work in conjunction with established entities providing collateral information pertaining to healthcare of the patient to a variety of healthcare providers such as the Living Will Registry and other similar entities. The various media provide the minimum for the required authorization of patient health information disclosure and serves as an interim authorization in an emergency until such time as a previously signed written authorization may be provided to the healthcare provider. The cards 10, 30 and 100 further provide identity confirmation information in conjunction with emergency and medical contact information to aid in the search, recovery and treatment of a missing person.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method of implementing a system of information onto a media instrument comprising:
a. compiling from a data provider a specialized set of data applicable to medical and police aid while upholding the confidentiality of the data provider;
b. loading the specialized set of data into a system configured to conform to guidelines set out by the data provider;
c. formatting the specialized set of data into sections and sub-sets to facilitate accessing and referencing the specialized set of data; and
d. transferring the specialized set of data onto a media instrument, the media instrument being a portable printed, engraved, or electronic means of carrying information.

2. The method of implementing a system of information onto the media instrument of claim 1, wherein the specialized set of data is selected from the group consisting of a set of personal information, a set of health care information, a set of health insurance information, a set of contact information, a set of legal information, and combinations thereof.

3. The method of implementing a system of information onto the media instrument of claim 2, wherein the set of personal information is selected from the group consisting of photographic identification, name, address, telephone number, date of birth, and combinations thereof.

4. The method of implementing a system of information onto the media instrument of claim 2, wherein the set of health care information is selected from the group consisting of allergies, health conditions, past surgeries, medications and dosages being taken, combinations thereof, wherein medications include prescription, over-the-counter, and herbal supplements.

5. The method of implementing a system of information onto the media instrument of claim 2, wherein the set of contact information is selected from the group consisting of identification of a patient's primary care physician, including the patient's primary care physician's contact information, identification of an emergency contact person, including the emergency contact person's contact information, identification of a care-giver, including the care-giver's contact information, and combinations thereof.

6. The method of implementing a system of information onto the media instrument of claim 2, wherein the set of legal information is selected from the group consisting of living will information, health care proxy information, medical power of attorney information, and combinations thereof.

7. The method of implementing a system of information onto the media instrument of claim 1, wherein the set of specialized data includes a set of specialized release information in a HIPPA-compliant format consisting of a signed written consent of a patient, giving authorization to contact and to treat the patient in accordance with the information provided within the set of specialized data.

8. The method of implementing a system of information onto the media instrument of claim 1, wherein the set of specialized data includes a set of identity information selected from the group consisting of a set of personal identity information, a set of emergency aid and personnel information, a set of identity confirmation information, a CodeAmber™ CD having a program for creating a Code Amber Alert and capable of being uploaded and sent out as a regional or national Amber Alert, a set of identity contact information, and combinations thereof.

9. The method of implementing a system of information onto the media instrument of claim 8, wherein the set of personal identity information is selected from the group consisting of photographic identification, name, address, telephone number, date of birth, age, physical description information, biological description information, health and medical information, health insurance information, emergency and alternative contact information, and combinations thereof.

10. The method of implementing a system of information onto the media instrument of claim 8, wherein the set of identity confirmation information is selected from the group consisting of a DNA sampling process kit, a fingerprint kit, and combinations thereof.

11. The method of implementing a system of information onto the media instrument of claim 8, wherein the set of identity contact information is selected from the group consisting of DNA and fingerprints location contact information, media instrument location contact information, primary care physician and dentist contact information and combinations thereof.

12. The method of implementing a system of information onto the media instrument of claim 1, wherein the media instrument is selected from the group consisting of ID cards, information sheets, booklets, ID bracelets, HIPPA authorization ID tags, USB flash memory, compact discs, electronic storage devices, and combinations thereof.

13. The method of implementing a system of information onto the media instrument of claim 1, further including the step of updating the set of specialized data to represent up-to-date information within the set of specialized data on the media instrument.
